(19) United States
(12) Patent Application Publication
(10) Pub. No.: US 2009/0066084 A1
(43) Pub. Date: Mar. 12, 2009

(54) Enhanced Electrical Power Supply Systems with Induction Generators and Related Methods of Operation

(76) Inventor: Douglas Moyles, Rocklin, CA (US)

Correspondence Address: WILSON SONSINI GOODRICH & ROSATI, 650 PAGE MILL ROAD, PALO ALTO, CA, 94304-1050, US

(21) Appl. No.: 12/144,528

(22) Filed: Jun. 23, 2008

Related U.S. Application Data
(60) Provisional application No. 60/971,557, filed on Sep. 11, 2007.

(51) Int. Cl. F02N 11/04; H02K 53/00

(52) U.S. Cl. 290/32; 415/916

(57) ABSTRACT

This invention is directed to enhanced electrical power supply systems with induction generators and related methods of operations. The invention is an enhanced prime mover system capable of converting the exergies of the prime mover system into energy input for the prime mover system to increase the overall efficiency of the prime mover and the overall efficiency of a generator. The enhanced prime mover system may enable a more economic generator system with greater flexibility of implementation.

### CROSS-REFERENCE

This application claims the benefit of U.S. Provisional Application No. 60/971,557 filed Sep. 11, 2007, which application is incorporated herein by reference.

### FIELD OF THE INVENTION

This invention is directed to enhanced electrical power supply systems with induction generators and related methods of operations. More particularly, the invention provides prime movers capable of converting the exergies of a prime mover system into energy input for a system, which may increase overall efficiency.

### BACKGROUND OF THE INVENTION

Historically, generators have absorbed some type of energy, whether that energy be mechanical, electrical, thermal, kinetic, or photovoltaic, from a reservoir and converted that energy into a usable form of exergy. However, the disadvantage of these types of conversions is that they may require large infrastructures and/or reservoirs of energy to maintain the inputs of energy. Also, these conversions have percentages of losses, and high percentages of inefficiencies. Because of this, there are problems arising from high energy consumption rates, and low energy usage efficiencies. Additionally, there may be large capital investments in infrastructure to maintain large reservoirs of capacity.

Some generator systems are dependent on very specific factors and may only work in certain situations, which can be very limiting. For instance, some electrical power supply systems are weather dependent systems, which can be very unreliable, or are time of day dependent. Some examples of such systems are wind and solar generating systems. Additionally, some generation sites are very location dependent, such as wind farms and hydroelectric dams. For some other alternate power-generating systems, there are problems with fossil fuel emissions and nuclear generation waste by-products.

An induction motor may be driven by a prime mover to act as an induction generator. See U.S. Pat. Pub. No. 2005/0127880, which is incorporated by reference in its entirety herein. The prime mover may comprise any driving mechanism such as an internal combustion engine, or any of the weather or location dependent mechanisms such as wind, water, or solar power. However, such prime mover systems may result in the limitations discussed previously regarding size and inefficiency, and time and location dependency. Inefficiencies and limitations of a prime mover may translate to inefficiencies and limitations of the electrical power supply system.

There is a need for an improved prime mover that is more efficient and does not require large infrastructures to maintain energy inputs, and that are not strictly limited by weather, time and location.

### SUMMARY OF THE INVENTION

The invention provides improved prime mover systems and related methods of operation. Various aspects of the invention described herein may be applied to any of the particular applications set forth below or for any other types of energy output systems requiring a prime mover. The invention may be applied as a standalone system or method, or as part of a multi-input point energy output system. It shall be understood that different aspects of the invention can be appreciated individually, collectively, or in combination with each other.

An aspect of the invention is directed to enhanced electrical power supply systems with induction generators and related methods of operations. For example, an enhanced prime mover system is provided that can convert the exergies of a system back into energy input for the prime mover system to increase the overall efficiency of the prime mover and the overall efficiency of a generator. The enhanced prime mover system may enable a more economic generator system with greater flexibility of implementation.

The prime mover system in a preferable embodiment may include a binary induction electrical generator set, a binary induction electrical generator set platform, vibration/sonic isolators, and a controls and electrical components enclosure. The binary induction electrical generator set may consist of a motor and a motor generator.

In another embodiment of the invention, the motor and motor generator may each have a sheave or pulley apparatus and may be connected to one another with a belt that goes around the sheaves. A starter may exert a force on the binary induction electrical generator set to start the prime mover system operation. For example, the starter force may be applied as a torque on the motor's rotor or may be applied directly to the belt itself to get it moving. The starter mechanism could vary, constituting anything from a battery/power source to a manual crank. The starter may be any sort of mechanism that may exert a force on the binary induction electrical generator set so that the prime mover system may start operating and may overcome the initial system inertia.

In another embodiment of the invention, the motor and motor generator may be connected to one another with a direct drive. The direct drive may include a generator set torque converter or shaft. A starter may exert a force on the binary induction electrical generator set to start the whole system operation. For instance, the starter force may be applied as a torque on the motor's rotor or on the direct drive component.

The prime mover system may include a controls or electrical components enclosure that may contain additional electrical components. For instance, the electrical components may include a push-pull piezoelectric microphone/converter, capacitors, and a light bulb or rectifier.

The binary induction electrical generator set may rest on a platform. The controls and electrical components enclosure may also rest on the platform. The platform may be elevated by a supporting member that may act as vibration/sonic isolators, which may keep the platform elevated and isolated from the ground or any grounding surface.

The advantages of this invention over previous systems are various and many. The prime mover's true power is a result of the constant reactive force to the system's useful exergies. Applications may include electrical generation, heating and cooling, modes of transportation, all known types of shaft work, and potentially many unfound uses for energy. This innovation is scalable and portable and can be applied to existing users of all types and forms of energy.

The prime mover systems and methods herein of converting exergies into energy inputs currently has several forms of constructability, tailored to the required output of the user's energy needs. The operation of the system may be relative to the work-load versus energy requirements of the user's demand curve at full load versus the torque curve during the startup cycles and slowdown cycles.

In a multi input-point system, such as an electric grid or fluid pumping route, the designs of a prime mover system may be tailored to be the input energy source to the drivers of those systems (i.e. electrical generators or pumps). In a stand alone operation, the innovation's system design may be tailored to the operation's characteristics required for optimum performance relative to energy usage.

Another prime mover design provided herein may convert the byproducts of several exergies of the prime mover system into the prime mover. In doing so, individual efficiencies of the systems may be cumulatively converted into a work multiplier, thereby converting the effect of any loss associated with a rate of change in one of the systems into a function of the efficiencies of the remaining systems.

For instance, the motor of the induction electrical generator set may produce exergy, which may be harnessed and add energy input back into the motor. When the motor operates, the act of the rotors turning may create electrical energy, the excess of which may be stored in the rotor and given a path through the rotor to add its own reactive force to the motor and may improve the motor efficiency.

Also, in one embodiment of the invention, the belt of the prime mover system may also create exergy which may be converted to useful energy. The belt itself may take the exergies that may originate from vibrations, friction or slippage, or that may result from the mechanical turning of the device or from moving through the air and conduct the energy back into the system. DC derived from the belt may flow into both the motor and the motor generator. The motor may be configured so that the rotor may have the ability to store energy and act as a capacitor.

The prime mover system may also utilize the system's exergies by using a push-pull piezoelectric microphone/converter, or a similar accelerometer-type device. The microphone/converter may act as a feedback system, and may create a sympathetic waveform and feed it back into the system. DC derived from the microphone/converter may flow into both the motor and the motor generator. The microphone/converter may be utilizing exergies that arise from sound and other vibrations, and may act as an additional inductor.

Capacitors may be included in the prime mover system in order to act as electromagnetic storage and smooth out the different levels of power. They may be able to store energy from slight variations and smooth out the energy output.

The prime mover system may also include a light bulb or rectifier, which may act as a heat exhaust or sink. The light bulb or rectifier may be able to remove heat while placing a relatively constant demand on the system, which may improve system efficiency.

Other goals and advantages of the invention will be further appreciated and understood when considered in conjunction with the following description and accompanying drawings. While the following description may contain specific details describing particular embodiments of the invention, this should not be construed as limitations to the scope of the invention but rather as an exemplification of preferable embodiments. For each aspect of the invention, many variations are possible as suggested herein that are known to those of ordinary skill in the art. A variety of changes and modifications can be made within the scope of the invention without departing from the spirit thereof.

### INCORPORATION BY REFERENCE

All publications and patent applications mentioned in this specification are herein incorporated by reference to the same extent as if each individual publication or patent application was specifically and individually indicated to be incorporated by reference.

### BRIEF DESCRIPTION OF THE DRAWINGS

The features and advantages of the invention may be further explained by reference to the following detailed description and accompanying drawings that sets forth illustrative embodiments.

FIG. 1 shows a top view and a side view of a prime mover structure with a belt drive.

FIG. 2 shows a top view and a side view of a prime mover structure with a direct drive.

FIG. 3 shows a motor including a magnetic harmonic amplifier/pump.

FIG. 4 shows a top view of a prime mover system.

FIG. 5 shows a circuit diagram of a prime mover system.

### DETAILED DESCRIPTION OF THE INVENTION

While preferable embodiments of the invention are shown and described herein, it will be obvious to those skilled in the art that such embodiments are provided by way of example only. Numerous variations, changes, and substitutions will be apparent to those skilled in the art without departing from the spirit and scope of the invention. It should be understood that various alternatives to the embodiments of the invention described herein may be employed in practicing the invention. It is intended that the following describe exemplary methods and apparatus falling within the scope of the invention.

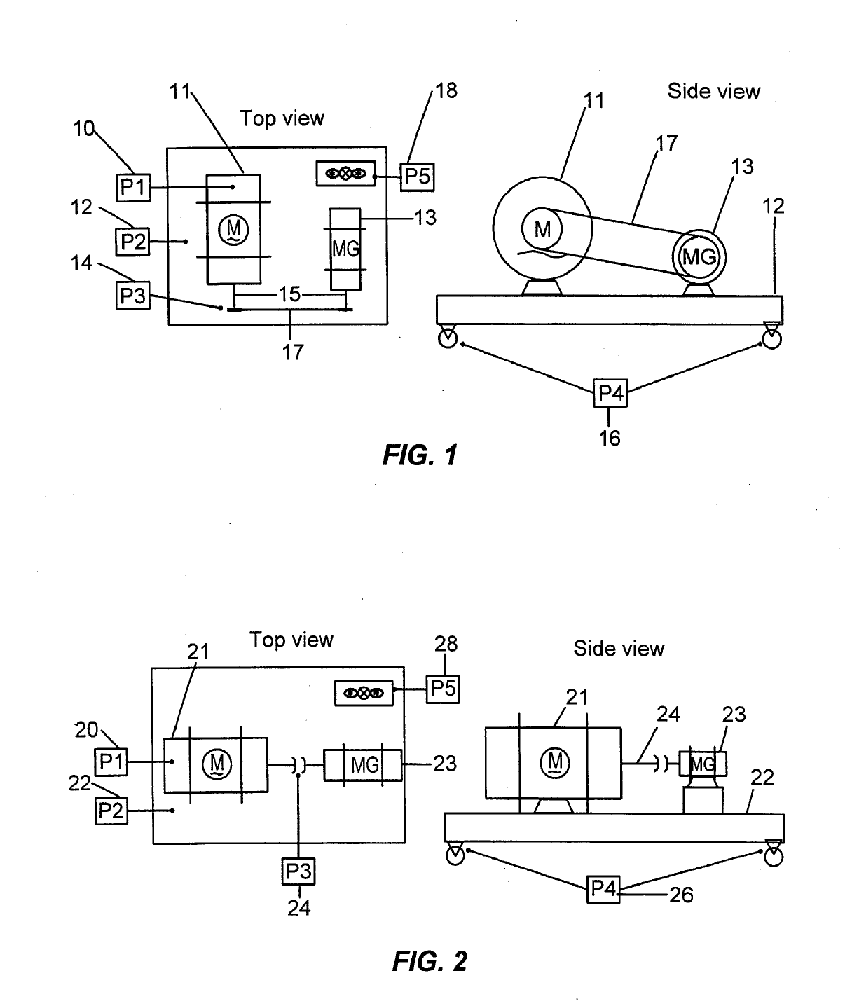

Referring to the drawings in detail, FIG. 1 shows a top view and side view of a prime mover structure with a belt drive. The prime mover structure may include a binary induction electrical generator set 10, a binary induction electrical generator set platform 12, generator set sheaves and belt 14, vibration/sonic isolators 16, and a controls and electrical components enclosure 18.

The binary electrical generator set 10 may include a motor 11 and a motor generator 13. In one embodiment of the invention, the motor 11 and motor generator 13 may be connected to one another through generator set induction sheaves and a belt 14. The motor 11 and motor generator 13 may each be connected to a sheave or pulley 15, which may have one or more belts 17 that go around them. A starter mechanism may exert a force on this binary induction electrical generator set 10 and belt system 14 in order to get the system to start operating.

The motor 11 and motor generator 13 may rest on the binary induction electrical generator set platform 12. The controls and electrical components enclosure 18 may also rest upon the platform 12. The platform 12 may be laminated. The platform 12 may have a supporting member beneath it, such as vibration/sonic isolators 16. The supporting member may keep the prime mover system isolated from the ground or any grounding surface and elevated above it. In one embodiment of the invention, the vibration/sonic isolators may consist of rollers.

FIG. 2 shows a prime mover structure with a direct drive. The prime mover structure may include a binary induction electrical generator set 20, a binary induction electrical generator set laminated platform 22, a generator set torque converter or a shaft 24, vibration/sonic isolators 26, and a controls and electrical components enclosure 28.

The binary electrical generator set 20 may include a motor 21 and a motor generator 23. In one embodiment of the invention, the motor 21 and motor generator 23 may be connected through some direct drive mechanism such as a torque converter or a shaft 24. The direct drive mechanism may be configured so that the parts connected to the motor 21 and the motor generator 23 do not make direct contact. For example, the direct drive may use an indirect hydraulic/magnetic system to act in the torque conversion. A starter mechanism may exert a force on this binary induction electrical generator set 20 and direct drive system in order to get the system to start operating.

The motor 21 and motor generator 23 with a direct drive system may rest on the binary induction electrical generator set platform 22. The controls and electrical components enclosure 28 may also rest upon the platform 22. The platform 22 may be laminated. The platform 22 may have a supporting member beneath it, such as vibration/sonic isolators 26. The supporting member may keep the prime mover system isolated from the ground or any grounding surface and elevated above it. In one embodiment of the invention, the vibration/sonic isolators may consist of rollers.

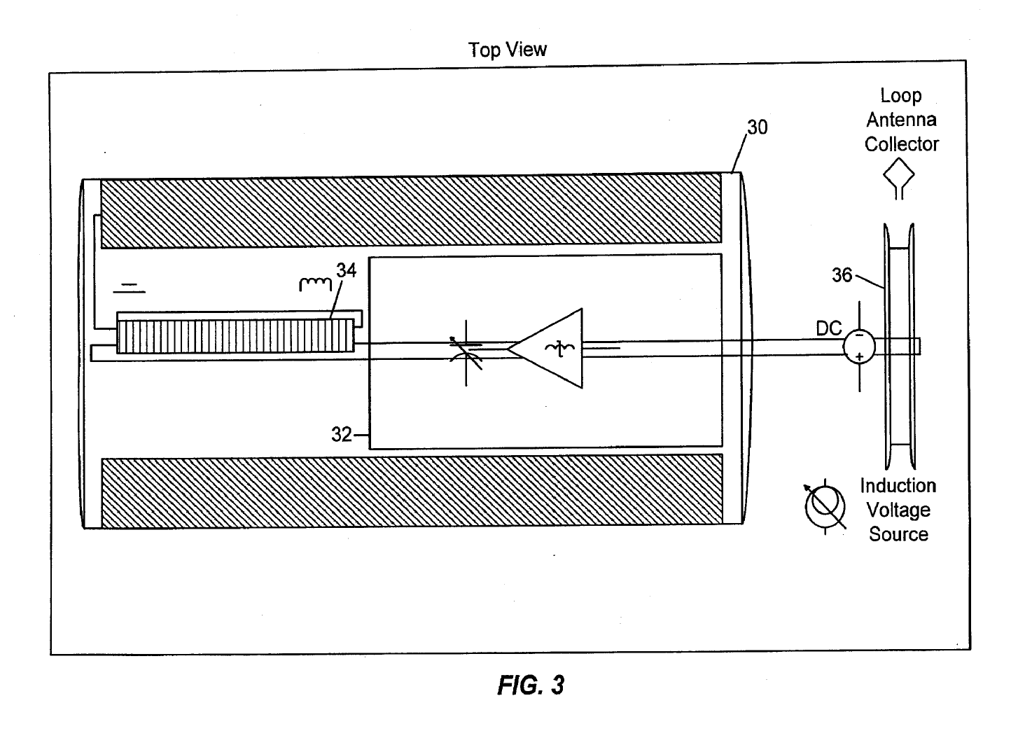

FIG. 3 shows a motor 30 including a magnetic harmonic amplifier/pump. This harmonic amplifier/pump may be part of the motor arrangement so that the motor is more efficient and utilize some of the exergies from the motor action.

The motor may include a rotor component 32 and current inductor 34. The rotor 32 may operate as an electromagnetic amplifier, a variable voltage capacitor, a variable amplitude, and a kinetic energy capacitor. The current inductor 34 may be continuously adjustable and may function as a DC accumulator.

The turning of the rotor 32 of the motor may create an exergy derived from the action of the rotor 32. An electrical energy may be derived from this exergy and may be stored within the rotor 32. The demand of the current inductor 34 may assist with the storing of the electrical energy. The rotor 32 and the current inductor 34 may be configured in such a way so that the excess electrical energy has a path through the rotor 32 in order to assist in the turning of the motor 30, thereby allowing the system to utilize this exergy.

The motor 30 may be connected to a sheave/pulley 36, which may be connected to a belt drive. The belt drive may be able to function as a loop antenna collector by conducting the energy derived from turning the belt drive and accompanying vibrations, friction or slippage, or interactions with surrounding air and the compression of humidity. The belt drive may conduct this energy so that a DC may flow into the motor 30 and may contribute to the energy derived from the exergy converted by the rotor 32, which may have a path for the current to flow inside the rotor 32 to add its own reactive force to the motor 30 and improve the system's efficiency.

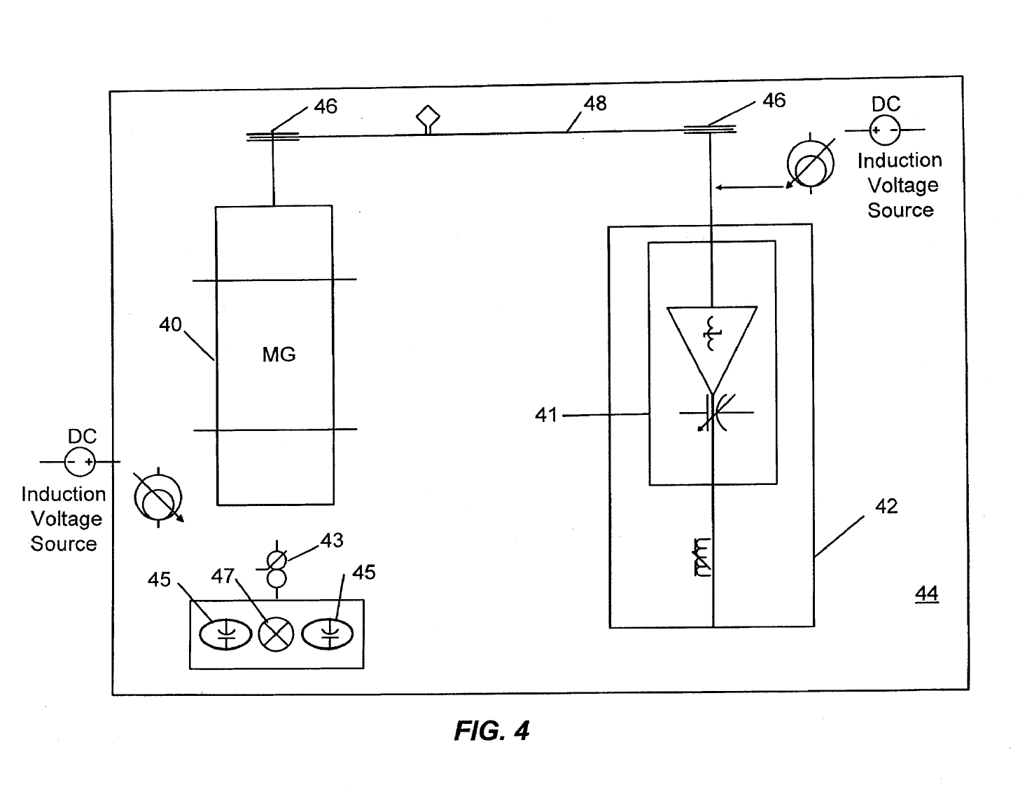

FIG. 4 shows a top view of a prime mover system. The prime mover system may include a motor generator 40, a motor 42, a controls and electrical components enclosure, and a platform 44.

The motor generator 40 and motor 42 may each be connected to a sheave or pulley apparatus. In one embodiment, the sheaves 46 may be connected to one another with a belt drive 48. The motor 42 may include a magnetic harmonic amplifier/pump as discussed in FIG. 3. The motor arrangement may enable the motor 42 to convert the exergies that may arise from the turning rotor 41 to electrical energy and may pass the energy through the rotor 41 to add to the energy input and allow the motor 42 to operate more efficiently. The stator portion of the motor may include a kinetic, induction, saturation, and averaging transformer with two or more phase winding. Such a transformer may be continuously adjustable and may enable binary DC induction with a single AC exovoltaic output.

The belt drive connecting the motor 42 and motor generator 40 may also convert system exergies into electrical energy. The belt itself 48 may take the exergies that may be derived from vibrations, friction or slippage, and the compression of humidity that may result from the mechanical turning of the device or from moving through the air and convert the exergies by acting as a conductor that can add energy back into the system. By doing so, the drive belt 48 may function as a loop antenna. Additionally, the material of the belt may have some level of pliability so that the turning of the sheaves may exert a force on the belt so that part of it may be compressed and part of it may be decompressed. This compression and decompression of the belt and the resulting compression of humidity may contribute to the system exergies that may be converted to usable energy inputted back into the system.

The prime mover system may also include controls and electric components that may be connected to the binary induction electrical generator set. The controls and electric components may include a push-pull piezoelectric microphone/converter 43 that may function as an EMP circuit exciter, a harmonic waveform regulator, or a continuously adjustable current inductor. The microphone/converter 43 may act as a feedback system, and may create a sympathetic waveform and feed it back into the system. The microphone/converter 43 may be feeding back energy derived from exergies that may arise from sound or other vibrations, and may act as an additional inductor by capturing sound. Thus, the microphone/converter 43 may act as another component to convert exergies of the prime mover system into a useful energy and improve efficiency. Other similar accelerometer-type devices may function in the same manner.

The controls and electric components may also include capacitors 45 that may act as a reservoir for electromotive force (EMF) and may provide resistance. As an EMF reservoir, the capacitors 45 may act as electromagnetic storage and smooth out the different levels of power. They may be able to store energy from slight variations and smooth out the energy output.

The controls and electric components may also include a light bulb or rectifier 47, which may act as a heat exhaust. The light bulb or rectifier 47 may be able to remove heat while placing a relatively constant demand on the system, which may improve the efficiency of the system.

The aforementioned arrangement of the prime mover system, including the motor and motor generator, and the controls and electrical components may rest on a platform.

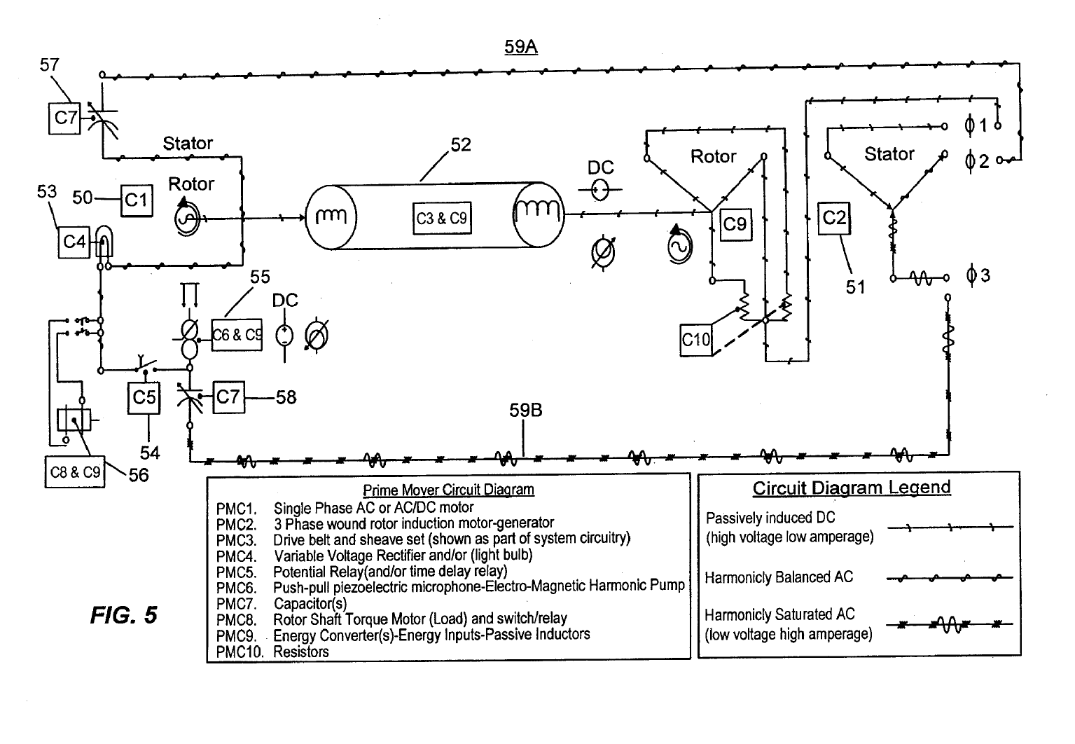

FIG. 5 shows a circuit diagram of a prime mover system. The circuit diagram of the prime mover system may include circuitry for a motor 50, a motor generator 51, a drive belt and sheave set 52, a light bulb or rectifier 53, a potential relay 54, a push-pull piezoelectric microphone/converter 55, and a load 56.

In one embodiment of the invention, the motor 50 may be a single phase AC or AC/DC motor. The motor 50 may be connected to a motor generator 51, which may be a three-phase wound rotor induction motor-generator. The motor 50 and motor generator 51 may be connected to one another with a drive belt and sheave set 52. The drive belt 52 may be able to convert and conduct the exergies derived from the drive belt turning, which may cause it to act as an inductor. The drive belt action, where the drive belt 52 may be acting as a conductor, may cause DC to flow into the motor generator 51 and the motor 50. In addition to the coupling between the motor 50 and motor generator 51 through the drive belt 52, they may be connected electronically so that electricity generated by the motor generator 51 may feed into the motor 50. The electricity to the motor 50 may pass through a capacitor 57. Energy from the motor generator 51 may also feed into the controls and electrical components which may feed into the motor 50 and into a load 56.

The electrical energy flowing from the motor generator 51 to the controls and electrical components may go through a capacitor 58 which may that may act as an EMF reservoir and provide resistance. The current may then flow through a push-pull piezoelectric microphone/converter 55 or similar accelerometer-type device which may act as a feedback system which can input a sympathetic waveform back into the system. The microphone/converter 55 may act as an additional inductor by capturing and converting exergies derived from sound and other vibrations and creating the sympathetic waveform. DC derived from the microphone/converter 55 may flow into both the motor 50 and the motor generator 51. Thus, the microphone/converter 55 may act as another component to convert an exergy of the prime mover system into a useful energy and improve efficiency.

The electrical energy flowing from the motor generator 51 may also encounter a potential relay switch 54, which may start in an open position before the system may start operating. When the prime mover system starts operating, an open potential relay switch 54 may allow the system to build enough potential to keep the motor running, and the relay switch 54 may close when enough potential has developed.

The circuitry may also include connections to a load 56. For example, the load 56 may be an induction generator system or other electrical power supply system that the prime mover may be driving.

The controls and electrical components of the prime mover system may also include a light bulb or rectifier 53 which may include variable voltage rectifier and may act as a heat exhaust. The light bulb or rectifier 53 may be connected to the motor 50. In one embodiment of the invention, the motor 50 may include a magnetic harmonic amplifier or pump to convert exergies of the system, such as those derived from the motor 50 or the belt drive 52, and input them back into the system.

The prime mover system may include leads wires, resistors, and other components that may assist with system implementation. In one embodiment of the invention, a connection between the motor 50 and motor generator 51 through the belt drive 52 and through the motor generator 51 and motor generator components may have passively induced DC. A wire 59A connecting the motor generator 51 to the motor 50 through a capacitor 57 may have harmonically balanced AC. A wire 59B connecting the motor generator 51 to a capacitor 58 before connecting to the microphone/converter 55 may have harmonically desaturated AC.

It should be understood from the foregoing that, while particular implementations have been illustrated and described, various modifications can be made thereto and are contemplated herein. It is also not intended that the invention be limited by the specific examples provided within the specification. While the invention has been described with reference to the aforementioned specification, the descriptions and illustrations of the preferable embodiments herein are not meant to be construed in a limiting sense. Furthermore, it shall be understood that all aspects of the invention are not limited to the specific depictions, configurations or relative proportions set forth herein which depend upon a variety of conditions and variables. Various modifications in form and detail of the embodiments of the invention will be apparent to a person skilled in the art. It is therefore contemplated that the invention shall also cover any such modifications, variations and equivalents.

What is claimed is:

1. A prime mover structure, comprising:
a motor;
a motor generator connected to the motor;
a platform supporting the motor and motor generator; and
at least one supporting member that elevates the platform.

2. The prime mover structure of claim 1 further comprising a component capable of converting an exergy into an electrical input.

3. The prime mover structure of claim 1 further comprising controls and electrical components connected to the motor and motor generator.

4. The prime mover structure of claim 1 wherein the supporting member is a rolling vibration or sonic isolator.

5. The prime mover structure of claim 1 wherein the motor and the motor generator are connected by a drive belt and sheave set.

6. The prime mover structure of claim 1 wherein the motor and the motor generator are connected by a direct drive.

7. The prime mover structure of claim 5 wherein the belt drive and sheave set converts exergies from belt drive motion into an electrical input.

8. A prime mover structure, comprising:
a binary induction electrical generator set with:
a motor; and
a motor generator connected to the motor;
a binary induction electrical generator set platform supporting the binary induction electrical generator set;
at least one supporting member that elevates the binary induction electrical generator set platform; and
a component capable of converting an exergy into an electrical input.

9. The prime mover structure of claim 8 further comprising controls and electrical components connected to the binary induction electrical generator set.

10. The prime mover structure of claim 8 wherein the supporting member is a rolling vibration or sonic isolator.

11. The prime mover structure of claim 8 wherein the motor and the motor generator of the binary induction electrical generator set are connected by a drive belt and sheave set.

12. The prime mover structure of claim 8 wherein the motor and the motor generator of the binary induction electrical generator set are connected by a direct drive.

13. The prime mover structure of claim 11 wherein the belt drive and sheave set converts exergies from belt drive motion into an electrical input.

14. The prime mover structure of claim 13 wherein the motor converts the electrical input into additional motive power.

15. An electromechanical energy conversion system comprising:
a motor;
a motor generator linked to the motor so that motive power is transmitted to and from the motor;
a platform supporting the motor and the motor generator; and
at least one supporting member that elevates the platform.

16. The electromagnetic energy conversion system of claim 15 further comprising controls and electrical components connected to the motor and motor generator.

17. The electro-magnetic energy conversion system of claim 15 wherein the motor converts an exergy from the motive power transmitted to and from the motor into additional motive power.

18. The electro-magnetic energy conversion system of claim 16 wherein the controls and electrical components include a microphone/converter component capable of converting vibrational exergies into electrical feedback.

19. The electromagnetic energy conversion system of claim 16 wherein the motor and motor generator are linked in a way that converts an exergy from the linkage into an electrical input.

20. A method for enhancing the operation of an electrical power supply comprising:
connecting a motor and a motor generator;
supporting the motor and the motor generator on a platform;
elevating the platform;
driving the motor and the motor generator; and
converting an exergy derived from driving the motor and the motor generator into an electrical input.

21. The method according to claim 20 wherein said connecting step is carried out by a belt drive and sheave set.

22. The method according to claim 20 wherein said connecting step is carried out by a direct drive.

23. The method according to claim 20 wherein converting an exergy is carried out by the motor.

24. The method according to claim 21 wherein converting an exergy is carried out by the belt drive and sheave set.

25. The method according to claim 20 further comprising connecting controls and electrical components to the motor and the motor generator.
